(19) United States
(12) Patent Application Publication
(10) Pub. No.: US 2022/0138630 A1
(43) Pub. Date: May 5, 2022

(54) PREDICTIVE STREAMING SYSTEM

(71) Applicant: Purdue Research Foundation, West Lafayette, IN (US)

(72) Inventors: Saurabh Bagchi, West Lafayette, IN (US); Nawanol Theera-Ampornpunt, West Lafayette, IN (US)

(73) Assignee: Purdue Research Foundation, West Lafayette, IN (US)

(21) Appl. No.: 17/516,497

(22) Filed: Nov. 1, 2021

Related U.S. Application Data
(60) Provisional application No. 63/108,049, filed on Oct. 30, 2020.

(51) Int. Cl. G06N 20/00; G06N 5/02

(52) U.S. Cl. CPC G06N 20/00; G06N 5/02

(57) ABSTRACT

System and methods for predictive application streaming are provided. The system may execute an application and, concurrently, the system may while load data blocks not stored on the device using a construct of superblocks. The system may detect an access event caused by an application accessing a data block in a memory. The system may determine, in response to the access event, a superblock comprising a plurality of blocks that are historically accessed within the same execution time window as the block. The system may forecast, based on the superblock and a machine learning model, superblocks to be accessed by the application that are not stored in the memory. The system may download the superblocks from a remote endpoint accessible via a network.

### CROSS REFERENCE TO RELATED APPLICATIONS

This application claims the benefit of U.S. Provisional Application No. 63/108,049 filed Oct. 30, 2020, the entirety of which is herein incorporated by reference.

### GOVERNMENT RIGHTS

This invention was made with government support under CNS-1513197 and CNS-1527262 awarded by the National Science Foundation. The government has certain rights in the invention.

### TECHNICAL FIELD

This disclosure relates to device storage management and, in particular, to coordination of local and cloud-based storage.

### BACKGROUND

Storage for mobile devices continue to outstrip available storage. The growth demands are driven by various factors including content-rich apps and mobile gaming. Realistic mobile gaming, in particular, takes up large amounts of storage on smartphones with some games taking about 200 MB and more demanding games, such as first-person shooter (FPS) games, taking 2-3 GB. The second factor is the increasingly powerful processors and graphics cards, high resolution displays, and ubiquitous network connectivity, which make it attractive to run these heavy apps and play these heavy games on mobile devices. Even well-endowed smartphones today a have 64-128 GB of internal storage, with a big chunk of this used by the OS itself and built-in apps that cannot be removed.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a first example of a system;

FIG. 2 illustrates a block diagram of superblock generation;

FIG. 3 a second example of a system;

FIG. 4 illustrates a flow diagram of example logic for a system; and

FIG. 5 illustrates a third example of a system.

### DETAILED DESCRIPTION

System and methods described herein introduce the app streamer framework, which alleviates the storage crunch on mobile devices for larger sized applications. Memory constraints a mobile device present may come at the expense of application performance and/or application experience. For example, content rich games/applications may require more memory. If the content is loaded from a remote server, the user may experience loading delays. For application and games, delays of a few tens of milliseconds are intolerable for the end-user. Even when local storage is not a constrained resource, application startup cause significant delays.

The system and methods described herein may mitigate stalls and/or startup costs of an application. The app streamer framework may predict the use of data blocks in the near future, based on file usage patterns of the application. The predicted blocks are then prefetched from a cloud storage with the goal of ensuring each data block is present on the device's storage before it is needed by the application.

Moreover, the system and methods described herein are agnostic to the actual game and thus needs no semantic understanding of the game or access to the source code of the game, either on the client or the server side. The app streamer balances two dimensions of the tradeoff—the amount of storage used on the device and the bandwidth used to bring data to the device versus the pause time inflicted on the user.

Additional and alternative benefits, efficiencies, and improvements over are made evident in the systems and methods described herein.

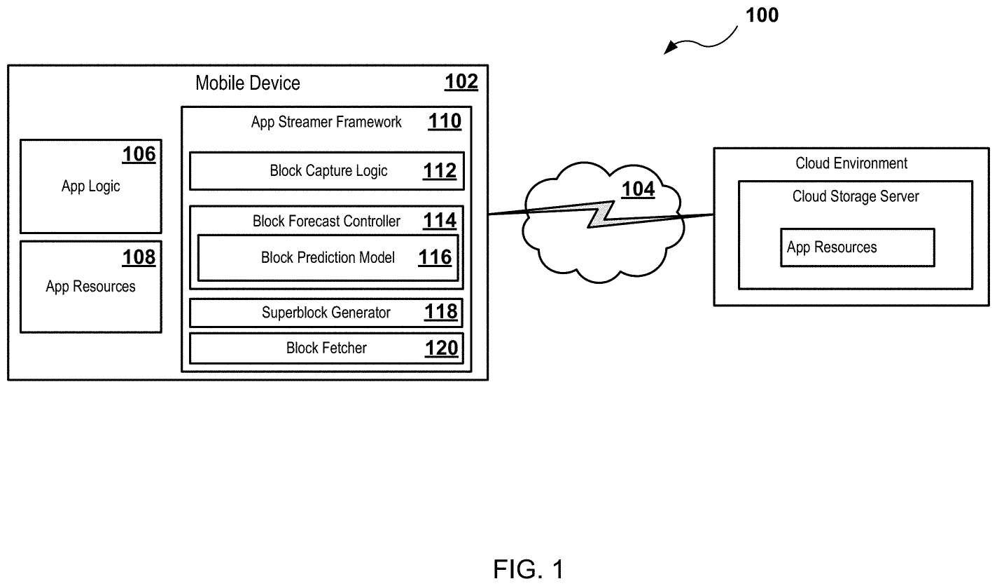

FIG. 1 illustrates a first example of a system 100. The system 100 may include a mobile device 102. The mobile device 102 may be any device which is capable of wirelessly loading an application, or resources for an application, over a communications network 104.

The mobile device 102 may include application logic 106. The application logic 106 may include instructions and/or logic that is included in an application package, such as an Android Application Package (APK), or the like. The application package may also include or reference application resources 108. The application resources 108 may be stored locally on the mobile device and/or in a cloud environment (either via a cloud storage server or application server). Alternatively, the resources 108 may be loaded separate from the application package. The resources 108 may include graphics, source code, and/or other data that is accessed during the course of execution of the application.

The system 100 may further include an app streamer framework 110. The app streamer framework 110 may capture file block access, forecast resources that will be accessed in the near future, and load the resources on demand so as to reduce storage while maintaining quick access. As long as the app streamer 110 predicts the application's file reads and fetch the required blocks before a request from the application, the application will work as if all files are present on the device. The system 100 may use past file reads to predict an application's file accesses. For example, the system may determine file read information including, for example, a file path, a file name, a file pointer position, number of bytes read, timestamp, or a combination thereof. The system may identify the accessed data block based on the read information.

An important aspect of the app streamer framework 110 is that it may run independent and concurrent with the application. Thus, for example, the app streamer may detect an application is loaded and then begin streaming application resources in response to detection of an application load event. The streaming may end in response to detection of an application close or sleep event.

The app streamer 110 may include block capture logic. The block capture logic 112 may capture file read events. For example, the block capture logic 112 may include a wrapper for the file read function at the virtual file system layer of the operating system. The information captured may include file path, file name, file pointer position, number of bytes to be read, timestamp, and/or other relevant information made available by the operation system. From the file pointer position and the number of bytes read, we can determine which block(s) are access.

In the offline (training) phase, file reads may be logged and written to a file, which will be for training. In the online phase, the file reads may be detected, captured, and used as input of a machine learning mode to make predictions in real time.

The system 100 may include a block forecast controller 114. The block forecast controller 114 may include (or access) a block prediction model 116. The block prediction model may be trained using file access traces collected from multiple devices running an application. The raw input to the prediction model 116 may be information captured by the block capture logic, such as the file read system calls by the app logic. The input features associated with each call may include, for example, file path, file name, file pointer position, number of bytes to be read, and timestamp. Alternatively, or in addition, the raw input to the block prediction model 116 may include a block identifier, which is identified based on the block capture logic. For example, in operating systems where the file system operates at the block level, each file read system call may be conferred into an access event for an individual block. In other examples, the raw input into the block prediction model may include a group identifier for multiple blocks, or superblocks (which is described further below).

In some examples, the block prediction model 116 may include a Continuous-Time Markov Chain (CTMC). The CTMC may capture the possible transitions between states as well as the duration spent at each state in a probabilistic manner. The duration information enables the block forecast controller to limit the lookahead when forecasting file access. Markov models are probabilistic in nature and the predictions provide probability associated with each predicted block. This enables the block capture logic to adjust the tradeoff between delay (due to a necessary block not being present) and potential waste of bandwidth and energy. The computational and memory overhead, as well as the accuracy of the prediction, depend on the states for the model.

The straightforward way to define the state of the CTMC is to use individual blocks read as the states. However, the memory, storage, and computational requirements may become too high. Consider that a 1 GB game has 250,000 4 KB blocks. In the worst case, we need to store close to 250,000²=62.5 Billion transition probabilities. Making predictions with the CTMC requires a depth-first-search, and having a branching factor of 250,000 makes the computation infeasible even at low depth limit, and the necessary depth limit can be quite high in this case.

Instead of using individual blocks read as the states, the block prediction model 116 may use groups of blocks as the states. In various experiments (see appendix) it was noticed that blocks tend to be accessed in groups, and these groups are similar across different users and different runs. Therefore, the block forest controller may group blocks together based on common patterns from different runs. It is observed that block grouping significantly reduces the memory, storage, and computational requirements of the model. As defined herein, groups of blocks are referred to as superblocks.

### Superblock Generator

The app streamer framework 110 may include a superblock generator 118. As mentioned above, grouping blocks is an advantageous step for state space reduction for the CTMC. A group of blocks are blocks that are frequently accessed together in multiple different runs (also referred to herein as superblocks). Sizing each group to be as large as possible reduces state space. An example approach, shown in Table 1, creates such groups when the number of blocks in a group times the number of runs accessing all the blocks in the group is sufficiently large. Note that there can be overlap between groups. The approach essentially summarizes the raw block accesses into essential information that the CTMC can easily process.

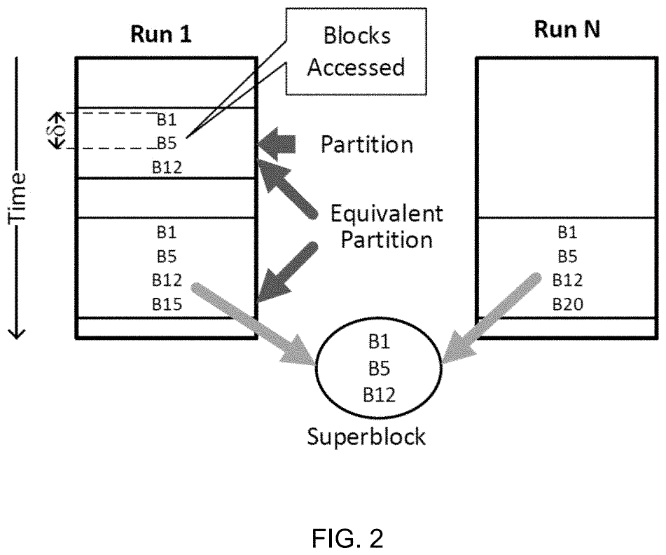

Referring to FIG. 2, block grouping can be divided into various operations provided by the superblock generator. In a first operation, the superblock generator group block reads in trace(s) that are close together in time into partitions. In a second operation, the superblock generator may generate equivalent partitions from the partitions by merging partitions that are sufficiently similar. In the third step, the superblock generator may extract overlaps in equivalent partitions from different trace runs to create groups of blocks which we call superblocks. Superblocks represent groups of blocks that are frequently accessed together, and they are used as input to the CTMC.

### Partitions

These operation(s), each trace run in the training data is processed separately to produce partitions. Each partition contains blocks that are accessed close together in time, with the threshold of maximum time between successive block reads specified by a parameter δ.

### Equivalent Partitions

Empirically, it was found that some partitions within the same trace run are very similar to each other. In order to remove redundant information, the superblock generator may merge near-identical partitions from the same trace into one equivalent partition. The superblock generator may use Jaccard index as the similarity metric with each partition considered as a set of data blocks. A Jaccard index of 1 means that both sets are identical, while a Jaccard index of 0 means there is no overlap between both sets. All pairs of partitions with Jaccard index higher or equal to a parameter denoted by τ are merged into one. No changes are made to partitions that are not sufficiently similar to any other partitions. After these steps, the superblock generator may have the equivalent partitions, which are used as input to the superblock step. The value for the parameter δ should be chosen to separate block reads in different “batches.” Empirically, the value should be between 1-1000 milliseconds.

### Superblock

Equivalent partitions generated in the previous step represents groups of blocks that are frequently accessed together within a single run. At this point, the superblock generator may essentially have one model per run. In order to utilize information about different playing styles and different execution paths, the superblock generator may need to combine information from different runs into a single model, while removing redundant information. Due to different timings and execution paths, equivalent partitions in multiple trace runs are not exactly identical. For example, an equivalent partition in one trace run can be made up of three equivalent partitions from another trace run, or may not show up at all in yet another trace run. The superblock generator may find large intersections of equivalent partitions across trace runs, process the intersection as a single unit of blocks, and remove the intersection from the equivalent partitions that contribute to the intersection. The superblock generator may then repeat the process until no large intersection can be found. Each large intersection may be referred to as a superblock. The challenge comes from the fact that the blocks in some equivalent partitions may not be present in all trace runs.

TABLE 1
Create superblocks from equivalent partitions

Function [symbol]
numSuperblockSize)

| \| | superBlocks ← { }; | | | |
|---|---|---|---|---|
| \| | while true do | | | |
| \| | \| | overlap ← [symbol] | | |
| \| | \| | numTraces, 1 null); | | |
| \| | \| | if [symbol] then | | |
| \| | \| | \| | break; | |
| \| | \| | end | | |
| \| | \| | remove blocks in overlap from the equivalent partitions | | |
| \| | \| | it originated from: | | |
| \| | \| | superBlocks.append(overlap); | | |
| \| | end | | | |
| \| | /* | Merge each remaining equivalent partitions | | |
| \| | | [symbol] | | |
| \| | for i ← [symbol] | | | |
| \| | \| | for [symbol] | | |
| \| | \| | \| | if equivPartitions[i][j].size > 0 then | |
| \| | \| | \| | \| | merge equivPartitions[i][j] into the closest |
| \| | \| | \| | \| | superblock, based on timestamp of original |
| \| | \| | \| | \| | equivalent partition from trace i. |

| | | | |
|---|---|---|---|
| \| | \| | \| | end |

| | | |
|---|---|---|
| \| | \| | end |

| | |
|---|---|
| \| | end |
| \| | return superBlocks, |

[symbol]

indicates data missing or illegible when filed

The pseudocode for creating superblocks is shown in Table 1. First, the superblock generator may find the largest overlap between any n equivalent partitions where each belongs to a different trace and n can be lower than the number of traces. The intuition behind not requiring n to be exactly the number of traces is that the playing/use style, and thus the file access patterns can be very different across traces, so a certain common pattern may not be present on all traces. For the purpose of this algorithm, the size of an overlap is defined as the number of blocks in the overlap multiplied by the number of contributing traces n. The blocks in this overlap are then removed from all of the contributing equivalent partitions, and put aside as a new superblock. The process repeats until the size of the overlap is lower than a threshold minSuperblockSize. At this point, the remaining equivalent partitions are merged into the superblocks that are closest in time. Recall that a superblock is the intersection of multiple equivalent partitions from different runs. For each contributing equivalent partition, the superblock takes the timestamp from it. For example, a superblock that comes from three runs will have three timestamps, each corresponding to a run. To determine which superblocks are closest in time to each remaining equivalent partition, the timestamp corresponding to the equivalent partition's run is used. At the end, each trace is transformed into a sequence of superblocks, which are then used as input to the block prediction model.

### Block Prediction Model

As previously discussed, a Markov chain is advantageous for block prediction. A Markov chain is specified by a number of states, the transitions among the states, and initial observation distribution. To capture the time duration spent in a state, the model includes duration, which is associated with each possible state transition to the model. Unlike the usual CTMC, where the duration follows an exponential distribution, we the Markov chain here may use the arithmetic mean and standard deviation of the duration derived from the training data. As described herein, each superblock may corresponds to a state in the CTMC. Time spent in a duration is independent of other parameters of Markov chain, which can be learned through the usual method.

To determine the current state, recent file reads are partitioned in the same way partitioning is done for training. With the most recent partition, the block forecast controller may find the superblock(s) that are a subset of this partition. If there are multiple superblocks, any arbitrary choice works well in practice because the lookahead is long enough that small differences in the starting state do not lead to widely divergent paths. The chosen superblock becomes the current state of the CTMC. In order to make predictions, from the current state, the block forecast controller may perform a depth-first search to compute the probability of each possible following sequence of future states. However, the number of possible sequences grows exponentially with the length of the sequence. To keep this computation feasible, the block forecast controller may prune the search in two ways: by stopping when the probability of reaching that particular state through a specific path is lower than a threshold pₛₜₒₚ or when the cumulative duration exceeds the lookahead time L. At the end, we have the probability of each superblock being read within the lookahead time. If this probability is higher than the block fetching threshold, denoted by p_{download}, then the blocks in the superblock that are not already on the device are added to the download queue. This parameter controls the tradeoff between downloading unnecessary blocks and the likelihood and amount of delay experienced by the user.

The lookahead may be adjusted dynamically. By way of example, the lookahead may be adjusted based on user skill. Since gamers with different skill levels often play games at different speeds, while the sequence of file block accesses may be the same, the file access forecast logic may take into account the user's playing speed when making prediction. As the user plays the game, the block forecast controller and/or some other component of the system 100, may detect time duration spent at each state, and compare it to the average duration learned by the model. Because playing speed only affects the duration between state transition, the effect of shorter duration can be simulated by increasing the lookahead time L. Therefore, when the block forecast controller makes predictions with the block prediction model, the lookahead time is adjusted, with a faster player getting higher lookahead, proportional to how fast she plays compared to the average. Similarly, different players may play in different ways, and this can result in different control paths being taken. Such information can also be captured by a single Markov model, by learning the probability of transitioning to state j given that the current state is i for all pairs of (i; j). This lets the block forecast controller utilize a single model for everyone, instead of having multiple models for each class of users, which would then require a classifier that determines the class of current user, as well as more training data.

It should be appreciated that each application may have a corresponding block prediction model. The block prediction model may be loaded when the application is loaded. Alternatively or in addition, the block prediction model may be included in the application package or available from other sources. The app streamer may load access the appropriate block prediction model for a particular application that is loaded or executed.

### Block Fetcher

The system may include a block fetcher 120. The block fetcher 120 may download data blocks from the cloud storage server. There are two types of blocks that need to be downloaded—predicted blocks for future needs and application-requested blocks for current needs. The predicted blocks are stored in a download queue in first-in, first-out (FIFO) order. The speculative block fetcher runs as a kernel thread and downloads predicted blocks in the download queue, using lowest network priority in order to not affect the responsiveness of other processes. Application-requested blocks need to be fetched urgently because the application, and by extension the user, is waiting for its response and so a request is sent immediately to the cloud storage server. The original read system call will block until the data is obtained.

On Android, an application's APK (Android Package Kit) is always immediately read in its entirety when the application is launched, so the entire APK may be stored on the device. Some other resource files may also be accessed at launch, or soon after. Since we do not have enough time to fetch these files during the short duration between application launch and when they are accessed, they are historically also be stored on the device. We denote the amount of file blocks that are stored on the device at all times (excluding the APK) by Bᵢₙᵢₜᵢₐₗ. This parameter controls the tradeoff between delay and amount of storage used.

### Temporary Storage Limit

In the current state of practice, all of a game's files are always typically stored on a given device. With the app streamer framework, only the APK and a small portion of the game's files (specified by Bᵢₙᵢₜᵢₐₗ) are always stored on the device. These files that are always stored on the device take up permanent storage (until the game is uninstalled). With app streamer, predicted blocks that are fetched speculatively are also stored on the device. However, they are deleted when the game's process terminates. Thus, we can say that these fetched blocks take up temporary storage on the device.

In the case where available free space is extremely limited, a hard limit on the temporary storage may be imposed. In this case, when the limit is reached, the block fetcher evict old blocks using the least recently used (LRU) eviction policy. Blocks that are predicted to be read in the near future are may not be evicted. This hard limit can have an effect on bandwidth usage and may introduce extra delays compared to when there is no limit.

### Operating System Support

The app streamer framework may be executed alongside most modern OS's. Although different OSes may use different file systems, the app streamer framework optimally works where files are organized in blocks, so it can be implemented in most OSes. The AppStreamer may operate in the layer between the mobile app and the device's operating system, requiring no changes to the app itself. For example, the application may be considered as a binary black box, and the app stream may only look at the interactions it has with the operating system, the file system, and/or memory.

### Capturing File Accesses (Android Example)

For both offline training and online prediction phases, a wrapper function may capture for the file read system call vfs_read at the virtual file system layer of the Android kernel. In the offline phase, the wrapper function records the file read if it is a relevant file (i.e., a file used by that game that is common across users), in a log file, before doing the actual file read and returning the requested data as usual. Information recorded includes file name and path, current file pointer, number of bytes requested, and timestamp. Empirically, it was found that the overhead of logging is not noticeable to the user. In various experiments, the average size of uncompressed log is 2.93 MB for 30 minutes of gameplay. It can be easily compressed if necessary due to repeated path and file names. In the online phase, the wrapper function passes on the information about the file read to the prediction model. If the requested blocks are already on the device, they are returned immediately to the caller. If the requested blocks are not on the device (i.e., a “cache miss”), the urgent block fetcher immediately requests the data from the cloud storage server.

Most file systems organize files as a collection of blocks. It is therefore natural for the app streamer framework to also operate at the granularity of blocks. In Android, each block is 4 KB in size. To simplify organization of blocks, we first create a file which acts as a container for all blocks and the app streamer framework creates a mapping from the game's accessed file name and block offset to the location in this file. A hash table in memory stores the mapping and since a game uses a limited number of blocks in its working set, the size of this hash table is small—with a 1 GB game and a liberal 25% of its blocks in the working set, the hash table is only 1 MB in size.

The system may be implemented with additional, different, or fewer components than illustrated. Each component may include additional, different, or fewer components

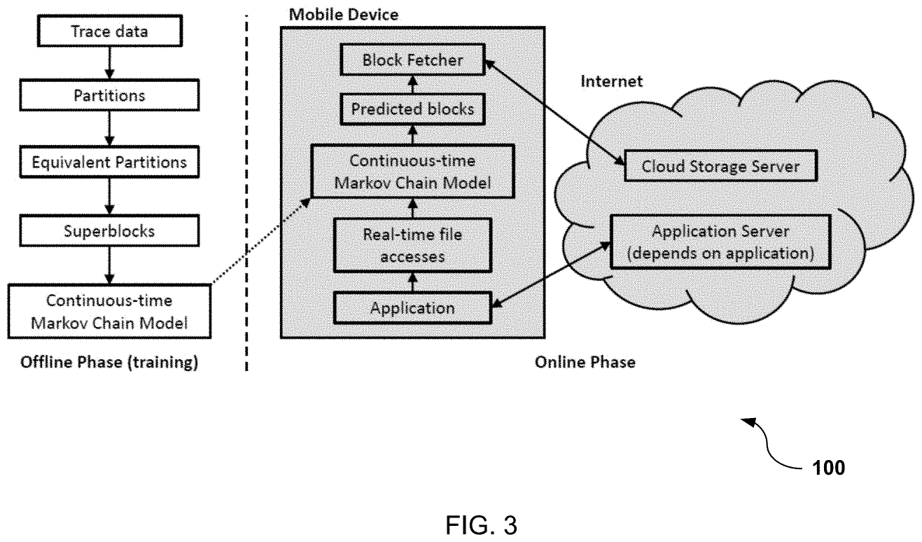

FIG. 3 illustrates a second example of the system. The cloud infrastructure may include the cloud server which stores the application parts to be streamed to the device and optionally, an application server in the cloud. FIG. 3 also illustrates offline training of the block prediction model and the online processes of predicting and pre-fetching the required parts of the application.

The various examples described herein often refer to a context of interactive games, because they are typically large in size and require high interactivity and thus low latency, though the concepts as well as the implementation also apply to other types of applications on mobile devices. Empirically, it is found that file blocks are accessed in granularities of tens of MB for most of the interactive games, as can be seen for the game Dead Effect 2. The jumps in the curves correspond to chunks of application content that are needed for the game, under different runs. Hence, the app streamer framework may perform accurate prediction of which chunks will be needed and initiate the prefetching with significant lookahead, considering that typical cellular network bandwidth is low, in the range 10-20 Mbps—the US average for LTE bandwidth is 13.95 Mbps.

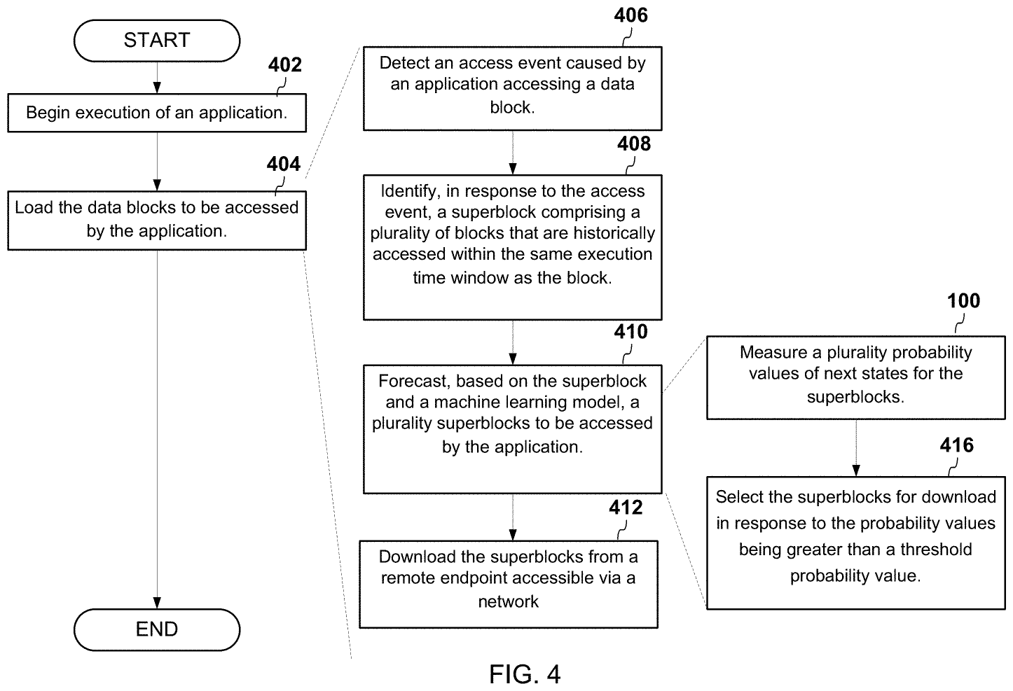

FIG. 4 illustrates a flow diagram of example logic for the system 100. The system 100, according to various embodiments, may include (or be included on) an electronic device. In some embodiments, the device may include a mobile device, such as a mobile phone, tablet, mobile gaming device, or the like. The system 100 may begin execution of an application on the device. The application may include, for example, a set of instructions which, when executed, provide an app or a game.

During execution of the game, the system 100 may load data blocks to be accessed by the application (404). As previously discussed it may be infeasble to load all of the resources that could possible be needed by a game ahead of time. Thus, the system 100 may predictively load the data blocks, as described throughout this specification and in the discussion regarding operations 406-412 in FIG. 4.

By way of example, the system 100 may detect an access event caused by an application accessing a datablock. The access event may be a read and/or write operation corresponding to data included in the datablock. The system 100 may identify, in response to detection of the access event, a superblock comprising a plurality of blocks that are historically access within the same execution window as the datablock corresponding to the access event (408). In some circumstances, the system 100 may dynamically determine the superblock. Alternatively or in addition, the system 100 may have previously identified the superblock based on historical usage.

The system 100 may forecast, based on the identified super block and a machine learning model, a plurality of superblocks likely to be accessed by the application. (410). For example, the system 100 may forecast which superblocks the application will access in the future, and which are not stored locally (i.e. not stored in a memory or file system of a device executing the application). The system 100 may download the forecasted superblocks from a remote endpoint accessible via network (412). The endpoint may include, for example, a server that stored application resources.

In some examples, to forecast the plurality of super blocks, the system 100 may include various logic that perform logic described through this specification. For example, the system 100 may measure a plurality of probability values of next states for the superblocks (414). In various examples, the machine learning model may be a Continuous-Time Markov Chain. The system 100 may determine the probability values of a particular time window. A time window is defined as a measurable passage of time which may be expressed, in some examples, as a duration, start/stop times boundaries, or the like. In some examples the time window may be extended or shortened dynamically while the application is executing to adjust quality of service and throttle bandwidth.

In some examples, the system may monitor user interaction with the application. A user may be interacting with the application according to a user profile. The user profile may have various attributes including, for example, an identifier of the user, a measure of advancement through a game (i.e. level, experience, etc.), and/or historical usage information. The historical usage information may include, for example, a log of interactions with the application, such as buttons clicked, menu's access, filed opened or, in the case of games, interactions with a game. In some examples, the interaction may be classified as a particular interaction type. The system may adjust the lookahead time window based on the interaction (or interaction type). For example, the interaction may be applied to a rule or model which generates provides an optimal lookahead time window based on the classified interaction.

The system 100 may select the superblocks for download in response to the probability values being greater than a threshold value (416). The threshold value may include, for example, the p_{download} value previously described in this specification.

The logic illustrated in the flow diagram may include additional, different, or fewer operations than illustrated. The operations illustrated may be performed in an order different than illustrated. The system 100 may be implemented with additional, different, or fewer components than illustrated. Each component may include additional, different, or fewer components.

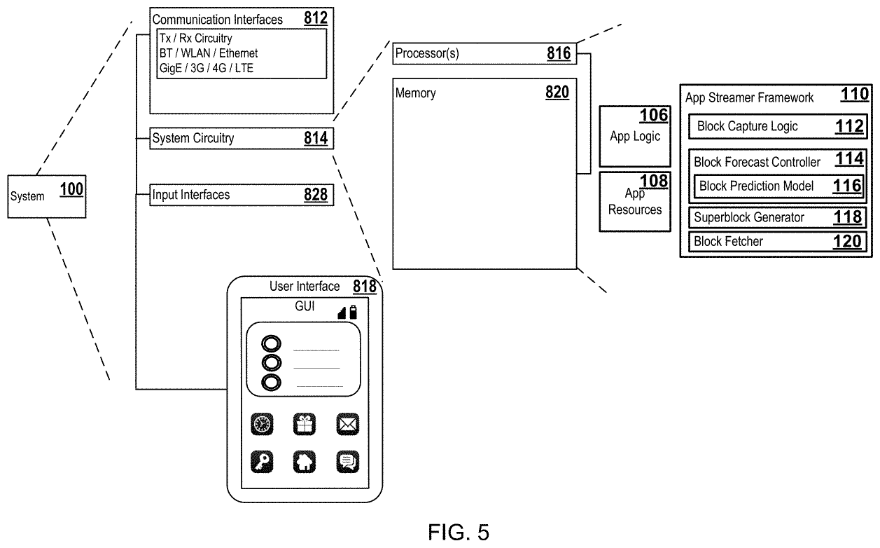

FIG. 5 illustrates a third example of the system 100. The system 100 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations of the app logic, the app resources, the app streamer framework, the block capture logic, the block forecast controller, the superblock generator, the bloc prediction model, the block fetcher, and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the app streamer framework, the app logic, the app resources, the block capture logic, the block forecast controller, the superblock generator, the bloc prediction model, the block fetcher, and/or the system 100. Alternatively or in addition, the memory may include any other component or sub-component of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many different ways. In some examples, the system 100 may be implemented with one or more logical components. For example, the logical components of the system 100 may be hardware or a combination of hardware and software. The logical components may include the app logic, the app resources, app streamer framework, the block capture logic, the block forecast controller, the superblock generator, the bloc prediction model, the block fetcher, and/or any component or subcomponent of the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A system, comprising:
a processor, the processor configured to:
execute an application; and
while executing the application, load a plurality of data blocks not stored on the device, wherein to load the data blocks, the processor is configured to:
detect an access event caused by an application accessing a data block in a memory;
determine, in response to the access event, a superblock comprising a plurality of blocks that are historically accessed within the same execution time window as the block;
forecast, based on the superblock and a machine learning model, a plurality superblocks to be accessed by the application that are not stored on the memory, and
download the superblocks from a remote endpoint accessible via a network.

2. The system of claim 1, wherein the machine leaning model comprises a Continuous-Time Markov Chain (CTMC).

3. The system of claim 2, wherein the superblock is associated with a first state in the CTMC, wherein to forecast the plurality of superblocks, the processor is further configured to:
measure a plurality probability values of next states for the superblocks, the probability values being a measurement of the next states occurring to the superblocks, respectively, after an occurrence of first state of the superblock; and
select the superblocks for download in response to the probability values being greater than a threshold probability value.

4. The system of claim 2, wherein the measured probability values are a measurement of the next states occurring to the superblocks, respectively, within a specified time window after occurrence of first state of the superblock

5. The system of claim 4, wherein the processor is further configured to:
adjust the lookahead time window during execution of the application.

6. The system of claim 5, wherein the processor is further configured to:
monitor user interaction with the application; and
adjust the lookahead time window based on the interaction.

7. The system of claim 4, wherein the application is associated with a user profile comprising a plurality of user attributes, wherein the processor is further configured to:
access at least one of the user attributes; and
adjust the lookahead window based on the user attribute.

8. The system of claim 1, wherein the processor is configured to execute the application in a user space and load the data block from a kernel space.

9. The system of claim 1, wherein the data block is at least a portion of a resource referenced by instructions in an application package.

10. The system of claim 9, wherein the application package comprises an Android application package.

11. A method, comprising:
executing, by a processor, an application;
loading, while executing the application, a plurality of data blocks not stored on a device having the processor, wherein to loading the data blocks comprises:
detecting an access event caused by an application accessing a data block in a memory;
determining, in response to the access event, a superblock comprising a plurality of blocks that are historically accessed within the same execution time window as the block;
forecasting, based on the superblock and a machine learning model, a plurality superblocks to be accessed by the application that are not stored on the memory; and
downloading the superblocks from a remote endpoint accessible via a network.

12. The method of claim 11, wherein the machine leaning model comprises a Continuous-Time Markov Chain (CTMC).

13. The method of claim 12, wherein the superblock is associated with a first state in the CTMC, wherein to forecasting the plurality of superblocks further comprises:
measuring a plurality probability values of next states for the superblocks, the probability values being a measurement of the next states occurring to the superblocks, respectively, after an occurrence of first state of the superblock; and
selecting the superblocks for download in response to the probability values being greater than a threshold probability value.

14. The method of claim 12, wherein the measured probability values are a measurement of the superblocks being accessed within a specified time window after occurrence of first state of the superblock.

15. The method of claim 14, further comprising:
adjusting the lookahead time window during execution of the application.

16. The method of claim 15, further comprising:
monitoring user interaction with the application; and
adjusting the lookahead time window based on the interaction.

17. The method of claim 14, wherein the application is associated with a user profile comprising a plurality of user attributes, the method further comprising:
accessing at least one of the user attributes; and
adjusting the lookahead window based on the user attribute.

18. The system of claim 11, wherein the processor is configured to execute the application in a user space and load the data block from a kernel space.

19. The method of claim 11, wherein the data block is at least a portion of a resource referenced by instructions in an application package.

20. The method of claim 19, wherein the application package comprises an Android application package.
